(19) United States
(12) Patent Application Publication
(10) Pub. No.: US 2024/0032704 A1
(43) Pub. Date: Feb. 1, 2024

(54) RADIO FREQUENCY WELDING TECHNIQUES TO EMBOSS GRAPHICS ON A TICKING MATERIAL

(71) Applicant: HILL-Rom Services, INC., Batesville, IN (US)

(72) Inventors: Joshua L. MEYER, Batesville, IN (US); Douglas E. BORGMAN, Brookville, IN (US); Jeffrey HOOG, Sunman, IN (US)

(21) Appl. No.: 18/355,806

(22) Filed: Jul. 20, 2023

Related U.S. Application Data
(60) Provisional application No. 63/393,014, filed on Jul. 28, 2022.

(51) Int. Cl. A47C 27/00; A47C 31/00; B29C 59/00; B29C 59/16

(52) U.S. Cl. CPC A47C 27/002; A47C 31/006; B29C 59/005; B29C 59/16; B29L 2031/751

(57) ABSTRACT

A system comprising a patient support surface including a core, a ticking covering the core, a RF welding equipment, and a die are used to emboss a layer of an embossing substrate to a surface of the ticking to form a 3-dimensional structure determined by the die. The ticking has a first surface that faces away from the core and a second surface that faces towards the core, and the 3-dimensional structure is formed on the second surface.

### PRIORITY CLAIM

This application claims priority under 35 U.S.C. § 119(e) to U.S. Provisional Application No. 63/393,014, filed Jul. 28, 2022, which is expressly incorporated by reference herein.

### BACKGROUND

The present disclosure relates to the use of a welding technique to emboss graphics on a surface of a ticking covering of a core. More specifically, the present disclosure is directed to systems and methods for embossing or debossing graphics on a covering material.

A ticking is made of materials used to cover and/or protect cores including mattresses used on patient support apparatus. Graphics or labels embossed on the ticking can be used by the user or caregiver to identify ticking characteristics. Various methods are currently implemented to apply graphics and/or labels to the surface of a ticking. Typical methods of embossing graphics include screen printing or digital printing. These methods are not always feasible and are cost prohibitive.

Thus, there is a need to develop new systems and methods that can increase the cost effectiveness and ease of applying graphics and/or labels to the surface of a ticking. The present disclosure is directed to the use of a radio frequency welding equipment for embossing graphics and/or labels to the surface of a ticking.

### SUMMARY

The present disclosure includes one or more of the features recited in the appended claims and/or the following features which, alone or in any combination, may comprise patentable subject matter.

According to a first aspect of the present disclosure, a system comprises a patient support surface including a core, a ticking covering the core, wherein the ticking has a first surface and a second surface, and wherein the first surface faces away from the core and the second surface faces towards the core, a radio frequency (RF) welding equipment and a die are used to emboss a layer of embossing substrate applied to the second surface of the ticking. The ticking forms a 3-dimensional structure determined by the die.

The core may be a mattress with a plurality of inflatable zones. The first surface of the ticking may be polyurethane and the second surface of the ticking may be nylon. The embossing substrate may be a thermoplastic or a thermoplastic coated substrate.

The first surface may comprise polyurethane and the second surface may comprise nylon, and the 3-dimensional structure may include a layer of embossing substrate, a layer of nylon, and a layer of polyurethane.

The die may comprise a graphic design, and the 3-dimensional structure formed by the die may comprise the same graphic design. The 3-dimensional structure may include an additional layer of color or foil. The additional layer of color may comprise a thermoplastic or thermoplastic coated substrate.

According to a second aspect of the present disclosure, a covering for a patient support surface may comprise a first surface and a second surface facing opposite to the first surface, a layer of embossing substrate applied on the second surface of the covering, and a 3-dimensional structure embossed on the covering. The 3-dimensional structure may comprise the layer of embossing substrate.

The covering may cover a core of a patient support apparatus. The first surface of the covering may be polyurethane and the second surface of the covering may be nylon. The embossing substrate may be a thermoplastic or thermoplastic coated substrate.

The 3-dimensional structure may include a layer of embossing substrate, a layer of nylon, and a layer of polyurethane.

A RF welding equipment and a die may be used to emboss the 3-dimensional structure on the covering. The 3-dimensional structure may include an additional layer of color or foil on the first surface.

According to a third aspect of the present disclosure, a method of applying a 3-dimensional structure to a ticking comprises the steps of selecting a radio frequency (RF) welding equipment, selecting a die compatible with the RF welding equipment, positing a first side of the ticking that will not be in contact with a core of a patient support surface and a second side of the ticking that will be in contact with the core of the patient support surface, applying a layer of an embossing substrate on the second side of the ticking, pressing the die on the embossing substrate on the first side of the ticking, and activating the RF welding equipment manually or automatically.

The method may comprise using an embossing substrate that is a thermoplastic or thermoplastic coated substrate. The method may comprise forming a 3-dimensional structure determined by the die. The method may further comprise applying a layer of color or foil to 3-dimensional structure. The additional layer of color on the first surface may comprise a thermoplastic or thermoplastic coated substrate.

Additional features, which alone or in combination with any other feature(s), such as those listed above and/or those listed in the claims, can comprise patentable subject matter and will become apparent to those skilled in the art upon consideration of the following detailed description of various embodiments exemplifying the best mode of carrying out the embodiments as presently perceived.

### BRIEF DESCRIPTION OF THE DRAWINGS

The detailed description particularly refers to the accompanying figures in which:

FIG. 1 is a diagrammatic illustration of a core covered by a ticking according to the present disclosure;

FIG. 2 is a diagrammatic illustration of two layers comprising the ticking;

FIG. 3 is perspective view of a patient support apparatus including a mattress covered by the ticking;

FIG. 4 is a diagrammatic illustration of the ticking with an embossed graphic on a top side;

FIG. 5 is a diagrammatic illustration of the ticking with an embossed graphic on a side surface;

FIG. 6 is a diagrammatic illustration of a die used to create the embossed graphic shown in FIG. 4;

FIG. 7 is a diagrammatic illustration of a RF equipment used to emboss graphics on the ticking; and

FIG. 8 is step by step illustration of a method implemented to create the embossed graphics on the ticking.

### DETAILED DESCRIPTION

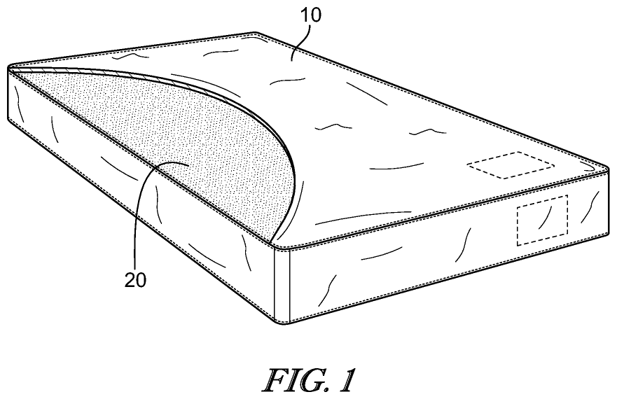

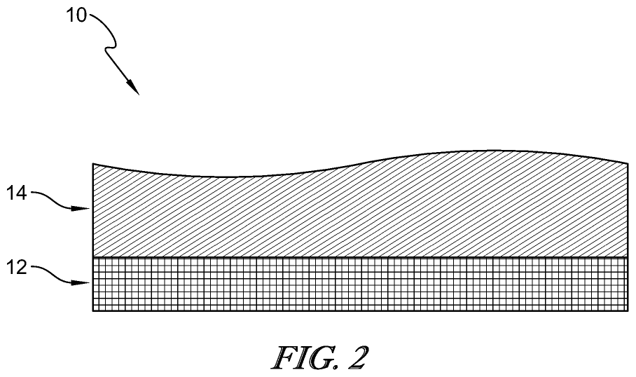

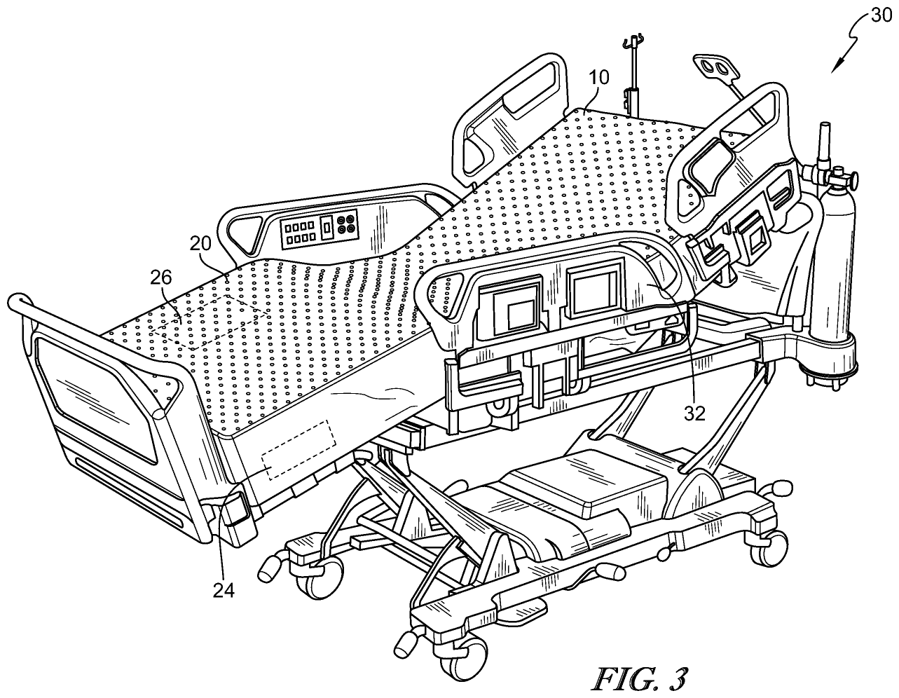

An illustration of a ticking 10 is shown in FIG. 1. The ticking 10 is used to cover a core 20 and can comprise one or more layers of material. In one embodiment, as shown in FIG. 2, the ticking comprises of a lower nylon layer 12 and an upper polyurethane layer 14. As shown in FIG. 3, the core 20 covered by the ticking 10 can be a mattress 20 on a patient support apparatus 30. The patient support apparatus 30 is embodied as a hospital bed. The bed 30 of FIG. 2 comprises a frame 32 which supports a mattress 20. The mattress 20 is covered by the ticking 10.

The ticking 10 can be used to cover a core 20 that may include inflatables pressure zones, or other fillings such as foam. The core 20 may comprise various core materials such as that disclosed in U.S. Pat. No. 11,135,110 titled “PATIENT SUPPORT APPARATUS,” which is incorporated herein for the disclosure of examples of core structures that can be covered by the ticking 10. The core can be used on patient support apparatuses including but not limited to beds, chairs, wheelchairs, operating tables, and changing tables.

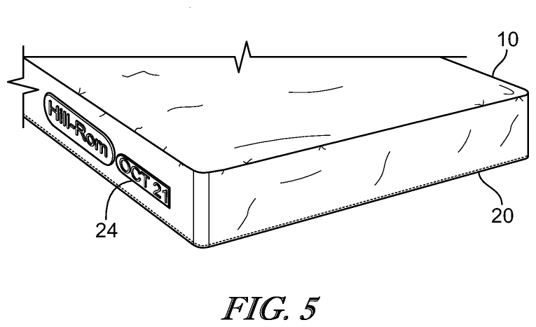

The ticking 10 can include one or more embossed graphics or labels. Graphics or labels embossed on the ticking 10 can be used by the user or caregiver to identify ticking 10 and/or core 20 characteristics. As shown in FIGS. 3-5, the ticking 10 can include embossed graphics 24, 26 on one or more surfaces. The embossed graphics 24, 26 are 3-dimensional structures that are added to the ticking 10 to communicate information to a patient or a caregiver. The embossed graphics 24, 26 can indicate product designation, caregiver instructions, specific locations (e.g., location of X-ray sleeve), etc.

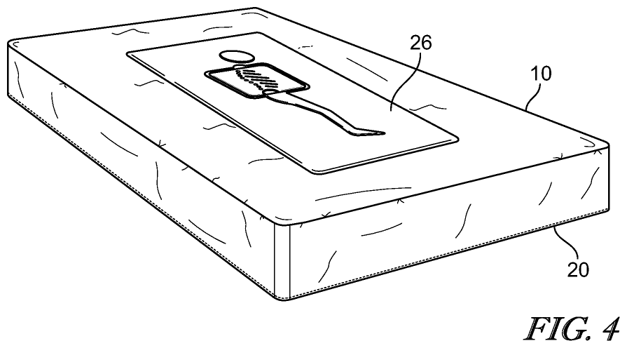

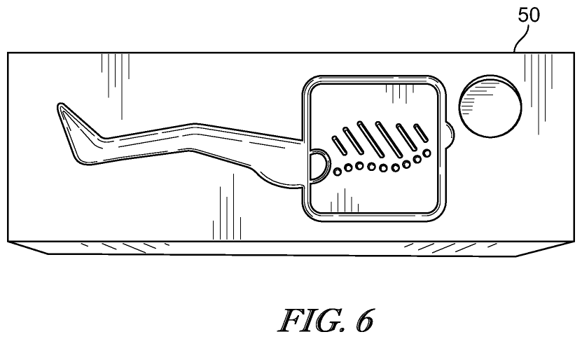

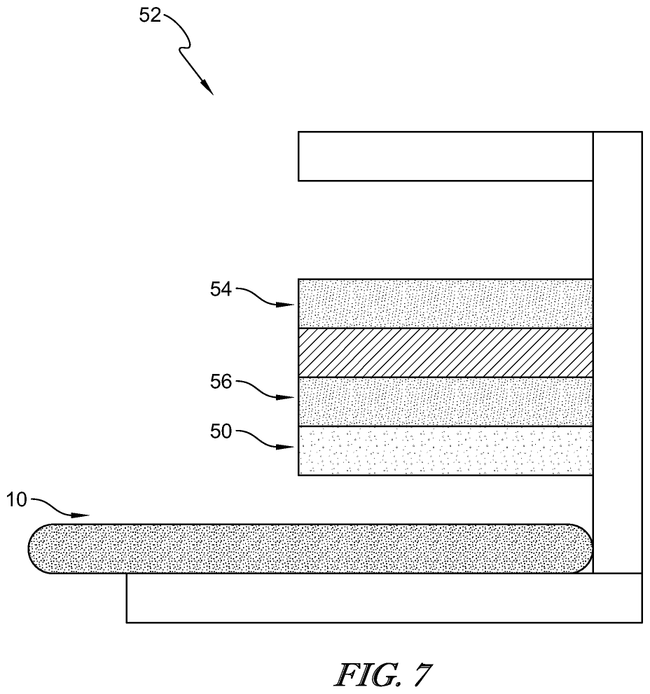

FIG. 6 shows the die 50 used to create the embossed graphic 24 illustrated in FIG. 4. FIG. 7 illustrates a typical RF equipment 52 that is used to create the embossed graphics 24, 26. The embossed graphics 24, 26 are applied by using a radio frequency (RF) welding technique that uses RF welding equipment 52 and a die 50. The structure of the embossed graphics 24, 26 is determined by the die 50. The RF welding equipment 52 creates the embossed graphics 24, 26 by applying radio frequency energy to the region of the ticking 10 when the embossed graphics 24, 26 are created. A high frequency electromagnetic field is applied between two metal bars 54, 56 which are also used to apply pressure to the region of the ticking 10. The radio frequency causes the molecules to oscillate creating friction. The friction gives rise to heat that results in the graphics being embossed onto the ticking 10.

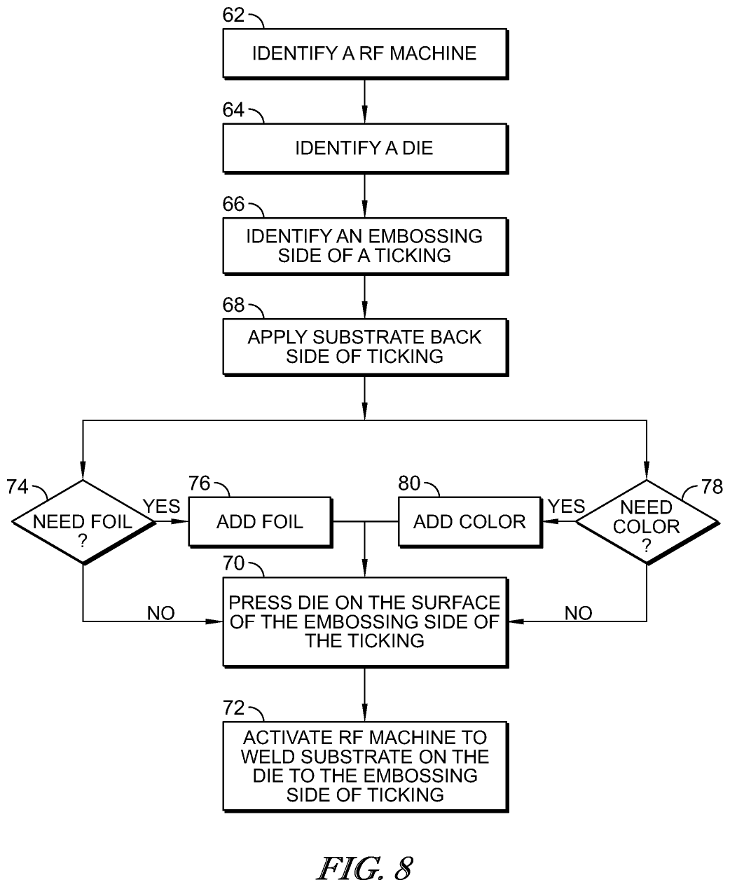

FIG. 8 is step by step illustration of a method implemented to create the embossed graphics 24, 26 on the ticking 10. The method of creating the embossed graphics includes identifying the correct RF welding equipment 52 in step 62 and identifying the appropriate die 50 in step 64. A side of the ticking 10 that is to be embossed is identified in step 66. A layer of embossing substrate is added to side of the ticking 10 that is to be embossed in step 68. The die 50 is pressed to the side of the ticking 10 that is to be embossed in step 70. The RF welding equipment 52 is activated to process the die 50 onto the ticking 10 in step 72. The RF welding equipment 52 can be operated manually or automatically. The embossing side of the ticking 10 may be the backside of the ticking 10 that is in contact with the core 20 or the topside of the ticking 10 that is away from the core 20.

The embossing substrate may be a thermoplastic or thermoplastic coated substrate. The embossing substrate may be ethylene, polypropylene, polyester, or polyurethane. The embossing substrate may be clear or may comprise a color. In one embodiment, the embossing substrate may have a thickness of about 0.15″. In other embodiments, the thickness of the embossing substrate may be more than or less than about 0.15″.

In some embodiments, an additional layer of color or foil may be added to the embossed graphics 24, 26. Referring back to FIG. 8, the method may include determining if a layer of foil is required in step 74. A foil may be added as a metal layer. If a layer of foil is determined to be required in step 74, step 76 is executed and a layer of foil is applied prior to pressing the die 50 in step 70. Alternatively, the foil layer may be added after the embossed graphics are added to the ticking 10 in step 72. The foil layer may be embossed on the graphic 24, 26 by heat. The foil layer may be applied to the side of the ticking 10 that is not in contact with the core 20 and/or is visible to the caregiver.

The method may further include determining if a layer of color is required in step 78. The layer of color can comprise a thermoplastic or thermoplastic coated substrate. If a layer of color is determined to be required in step 78, step 80 is executed and a layer of color is applied prior to pressing the die 50 in step 80. A layer of color may be applied to the side of the ticking 10 that is not in contact with the core 20 and/or is visible to the caregiver.

Alternatively, the layer of color may be added after the embossed graphics 24, 26 are added to the ticking 10 in step 72 on top of the polyurethane layer 14. The layer of color or foil may be added to the ticking 10 before, during, or after using the RF welding equipment and die 50 to create the embossed graphics 24, 26.

Although this disclosure refers to specific embodiments, it will be understood by those skilled in the art that various changes in form and detail may be made without departing from the subject matter set forth in the accompanying claims.

1. A system comprising:
a patient support surface including a core,
a ticking covering the core, wherein the ticking has a first surface and a second surface, and wherein the first surface faces away from the core and the second surface faces towards the core, and
a radio frequency (RF) welding equipment and a die used to emboss a layer of an embossing substrate applied to the second surface of the ticking,
wherein the ticking forms a 3-dimensional structure determined by the die.

2. The system of claim 1, wherein the core is a mattress with a plurality of inflatable zones.

3. The system of claim 1, wherein the first surface of the ticking is polyurethane and the second surface of the ticking is nylon.

4. The system of claim 1, wherein the embossing substrate is a thermoplastic coated substrate or a thermoplastic coated substrate.

5. The system of claim 1, wherein the first surface comprises polyurethane and the second surface comprises nylon, and wherein the 3-dimensional structure includes the layer of the embossing substrate, a layer of nylon, and a layer of polyurethane.

6. The system of claim 1, wherein the die comprises a graphic design, and the 3-dimensional structure formed by the die comprises the same graphic design.

7. The system of claim 1, wherein the 3-dimensional structure includes an additional layer of color or foil.

8. The system of claim 7, wherein the additional layer of color comprises a thermoplastic coated substrate or a thermoplastic coated substrate.

9. A covering for a patient support surface, the covering comprising:
a first surface and a second surface facing opposite to the first surface,
a layer of an embossing substrate applied on the second surface of the covering, and
a 3-dimensional structure embossed on the covering, wherein the 3-dimensional structure comprises the layer of the embossing substrate.

10. The covering of claim 9, wherein the covering covers a core of the patient support apparatus.

11. The covering of claim 9, wherein the first surface of the covering is polyurethane and the second surface of the covering is nylon.

12. The covering of claim 9, wherein the embossing substrate is a thermoplastic coated substrate or a thermoplastic coated substrate.

13. The covering of claim 9, wherein the first surface comprises polyurethane and the second surface comprises nylon, and wherein the 3-dimensional structure includes the layer of the embossing substrate, a layer of nylon, and a layer of polyurethane.

14. The covering of claim 9, wherein a RF welding equipment and a die are used to emboss the 3-dimensional structure on the covering.

15. The covering of claim 9, wherein the 3-dimensional structure includes an additional layer of color or foil on the first surface.

16. A method of applying a 3-dimensional structure to a ticking comprising the steps of:
selecting a radio frequency (RF) welding equipment,
selecting a die compatible with the RF welding equipment,
positing a first side of the ticking that will not be in contact with a core of a patient support surface and a second side of the ticking that will be in contact with the core of the patient support surface,
applying a layer of an embossing substrate on the second side of the ticking,
pressing the die on the embossing substrate on the first side of the ticking, and
activating the RF welding equipment manually or automatically.

17. The method of claim 16, wherein the embossing substrate is a thermoplastic coated substrate or a thermoplastic coated substrate.

18. The method of claim 16, wherein the method comprises forming a 3-dimensional structure determined by the die.

19. The method of claim 18, wherein the method further comprises applying a layer of color or foil to the 3-dimensional structure.

20. The system of claim 19, wherein the additional layer of color on the first surface comprises a thermoplastic coated substrate or a thermoplastic coated substrate.
